(19) United States
(12) Patent Application Publication
(10) Pub. No.: US 2016/0148037 A1
(43) Pub. Date: May 26, 2016

(54) METHOD FOR REGISTERING AND AUTHENTICATING FINGERPRINT AND ELECTRONIC DEVICE IMPLEMENTING THE SAME

(71) Applicant: Samsung Electronics Co., Ltd., Gyeonggi-do (KR)

(72) Inventors: Seunggeol BAEK, Gyeonggi-do (KR); Jeongmin PARK, Gyeonggi-do (KR); Jaeyub KIM, Gyeonggi-do (KR); Kihong MIN, Seoul (KR); Kihun EOM, Gyeonggi-do (KR); Donghan LEE, Gyeonggi-do (KR); Jeongho CHO, Gyeonggi-do (KR)

(21) Appl. No.: 14/941,778

(22) Filed: Nov. 16, 2015

(30) Foreign Application Priority Data
Nov. 21, 2014 (KR) 10-2014-0163721

(51) Int. Cl. G06K 9/00; G06F 3/044

(52) U.S. Cl. CPC G06K 9/0002; G06F 3/044; G06K 9/00087

(57) ABSTRACT

An electronic device and method for fingerprint authentication are disclosed. The electronic device may include a sensor unit including a first sensor area for detecting a fingerprint via a swipe operation and a second sensor area for detecting the fingerprint via a touch operation, and at least one processor, which may implemented the method. The method may include detecting a touch input to the sensor unit and activating one of the first sensor area and the second sensor area according to whether the touch input is the swipe operation or the touch operation, and storing fingerprint information obtained through the activated first sensor area or second sensor area.

### CLAIM OF PRIORITY

This application claims the benefit under 35 U.S.C. §119(a) of a Korean patent application filed on Nov. 21, 2014 in the Korean Intellectual Property Office and assigned Serial No. 10-2014-0163721, the entire disclosure of which is hereby incorporated by reference.

### TECHNICAL FIELD

Various embodiments of the present disclosure relate to a method for registering and authenticating a fingerprint and an electronic device implementing the same.

### BACKGROUND

Recently, electronic devices provide various services beyond telecommunication and message transmission functions. The various services may utilize personal information, and a user would store personal information (e.g., such as a resident registration number or a public authentication password or key) in the electronic device in order to receive or operate the respective services.

The security of the electronic device has become important because criminal behavior can be facilitated when the personal information is stolen. In order to enhance the security of electronic device, various functions such as a password, pattern drawing, and fingerprint recognition have been implemented.

### SUMMARY

Among the above-listed functions, the fingerprint recognition implements a relatively high degree of security utilizing a fingerprint sensor of a predetermined size. However, problems may arise because the recognition of fingerprints can deteriorate due to insufficient space in the electronic device for installing a fingerprint sensor, or due to installation of a small fingerprint sensor in the limited space.

Various embodiments of the present disclosure provide a method for registering and authenticating a fingerprint, and an electronic device implementing the same. The present disclosure can secure a relatively larger area for use with finger print authentication, in a limited space and more easily leverage the authentication.

In one embodiment of the present disclosure, an electronic device is disclosed, including a sensor unit including a first sensor area for detecting a fingerprint via a swipe operation and a second sensor area for detecting the fingerprint via a touch operation, and at least one processor configured to: detect a touch input to the sensor unit and activating one of the first sensor area and the second sensor area according to whether the touch input is the swipe operation or the touch operation, and store fingerprint information obtained through the activated first sensor area or second sensor area.

In another embodiment of the present disclosure, a fingerprint authentication method is disclosed, including: detecting by at least one processor a touch input to a fingerprint sensor and determining whether the touch input is a swipe operation or a touch operation according to whether the touch input includes movement, activating one of a first sensor area and a second sensor area of the fingerprint sensor according to the determination, and storing fingerprint information received through the activated first sensor area or second sensor area.

### BRIEF DESCRIPTION OF THE DRAWINGS

The embodiments of the present disclosure will be more apparent from the following description taken in conjunction with the accompanying drawings, in which:

FIG. 1 is a block diagram illustrating a configuration of electronic device according to various embodiments of the present disclosure;

FIG. 2 is a flowchart illustrating a method for registering and authenticating a fingerprint according to various embodiments of the present disclosure;

FIG. 3 is a drawing illustrating a fingerprint sensor executing a method for registering and authenticating a fingerprint according to various embodiments of the present disclosure;

FIG. 4 is a flowchart illustrating a method for registering and authenticating a fingerprint according to various embodiments of the present disclosure;

FIG. 5 is a flowchart illustrating a method for registering and authenticating a fingerprint according to various embodiments of the present disclosure;

FIG. 6 is a drawing illustrating a fingerprint sensor for executing operations of FIG. 5;

FIG. 7 is a flowchart illustrating a method for registering and authenticating a fingerprint according to various embodiments of the present disclosure;

FIG. 8 is a drawing illustrating a fingerprint sensor for executing operations of FIG. 7;

FIG. 9 is a flowchart illustrating a method for registering and authenticating a fingerprint according to various embodiments of the present disclosure; and

FIG. 10 illustrates screen examples of registering and authenticating a fingerprint according to various embodiments of the present disclosure.

### DETAILED DESCRIPTION

Hereinafter, embodiments of the present disclosure will be described in detail with reference to the accompanying drawings. It will be easily appreciated to those skilled in the art that various modifications, additions and substitutions are possible from the embodiment of the present disclosure, and the disclosure should not be limited to the following embodiments. The embodiments of the present disclosure are provided such that those skilled in the art completely understand the disclosure. In the drawings, the same or similar elements are denoted by the same reference numerals even though they are depicted in different drawings.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., and/or the like, may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although for both of them the first user device and the second user device are user devices. For example, a first element could be termed a second element, and similarly, a second element could be also termed a first element without departing from the present disclosure.

In the case where according to which a component is referred to as being “connected” or “accessed” to other component, it should be understood that not only the component is directly connected or accessed to the other component, but also another component may exist between the component and the other component. Meanwhile, in the case where according to which a component is referred to as being “directly connected” or “directly accessed” to other component, it should be understood that there is no component therebetween.

The terms used in the present disclosure are used to describe specific various embodiments, and are not intended to limit the present disclosure. Singular forms are intended to include plural forms unless the context clearly indicates otherwise.

Unless otherwise defined, all terms including technical and/or scientific terms used herein have the same meaning as commonly understood by one of ordinary skill in the art to which the disclosure pertains. In addition, unless otherwise defined, all terms defined in generally used dictionaries may not be overly interpreted.

For example, the electronic device corresponds to a combination of at least one of the followings: a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., MP3 player), a mobile medical device, a camera, or a wearable device. Examples of the wearable device are a head-mounted-device (HMD) (e.g., electronic eyeglasses), electronic clothing, an electronic bracelet, an electronic necklace, an appcessory, an electronic tattoo, a smart watch, etc.

The electronic device according to the embodiments of the present disclosure may be smart home appliances. Examples of the smart home appliances are a television (TV), a Digital Video Disk (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, or the like.

The electronic device according to the embodiments of the present disclosure may include at least one of the following: medical devices (e.g., Magnetic Resonance Angiography (MRA), Magnetic Resonance Imaging (MRI), Computed Tomography (CT), a scanning machine, an ultrasonic scanning device, etc.), a navigation device, a Global Positioning System (GPS) receiver, an Event Data Recorder (EDR), a Flight Data Recorder (FDR), a vehicle infotainment device, an electronic equipment for ships (e.g., navigation equipment, gyrocompass, etc.), avionics, a security device, a head unit for vehicles, an industrial or home robot, an automatic teller's machine (ATM), a point of sales (POS) system, etc.

The electronic device according to the embodiments of the present disclosure may include at least one of the following: furniture or a portion of a building/structure, an electronic board, an electronic signature receiving device, a projector, various measuring instruments (e.g., a water meter, an electric meter, a gas meter and a wave meter), etc. respectively. The electronic device according to the embodiments of the present disclosure may also include a combination of the devices listed above. In addition, the electronic device according to the embodiments of the present disclosure may be a flexible device. It is obvious to those skilled in the art that the electronic device according to the embodiments of the present disclosure is not limited to the aforementioned devices.

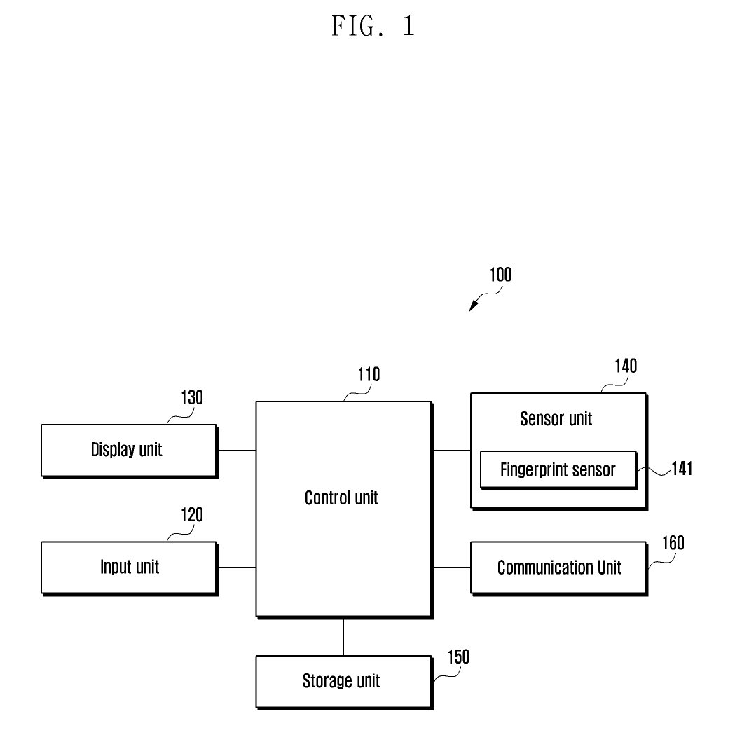

Hereinafter, electronic devices according the embodiments of the present disclosure are described in detail with reference to the accompanying drawings. In the description, the term a ‘user’ may be referred to as a person or a device that uses an electronic device, e.g., an artificial intelligent electronic device. FIG. 1 is a block diagram illustrating a configuration of electronic device according to various embodiments of the present disclosure.

Referring to FIG. 1, the electronic device 100 may include a control unit 110, input unit 120, display unit 130, sensor unit 140, and storage unit 150.

Examples of the electronic device 100 include smartphone, table Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical appliance, camera, wearable device (e.g. a head-mounted device (HMD) such as electronic glasses, electronic clothing, electronic bracelet, electronic necklace, electronic appcessory, electronic tattoo, smartwatch, etc.

According to various embodiments, the electronic device 100 is one of smart home appliances having operation support function. Examples of the smart electronic appliance as an electronic device include television, Digital Video Disk (DVD) player, audio player, refrigerator, air-conditioner, vacuum cleaner, electronic oven, microwave oven, laundry machine, air cleaner, set-to box, TV box (e.g. SAMSUNG HOMESYNC™, APPLE TV™, and GOOGLE TV™), game console, electronic dictionary, electronic key, camcorder, and electronic frame, etc.

According to various embodiments, examples of the electronic device 100 include medical device (e.g. Magnetic Resonance Angiography (MRA), Magnetic Resonance Imaging (MRI), Computed Tomography (CT)), Navigation device, Global Positioning System (GPS) receiver, Event Data Recorder (EDR), Flight Data Recorder (FDR), car infotainment device, maritime electronic device (e.g. maritime navigation device and gyro compass), aviation electronic device (avionics), security device, vehicle head unit, industrial or home robot, Automatic Teller's Machine (ATM) of financial institution, Point Of Sales (POS), etc.

According to various embodiments, examples of the electronic device 100 include furniture and building or structure having a communication function, electronic board, electronic signature receiving device, projector, and metering device (e.g. water, electric, gas, and electric wave metering devices). According to various embodiments, the electronic device 100 is any combination of the aforementioned devices. According to various embodiments of the present disclosure, the electronic device 100 is a flexible device. It is obvious to those skilled in the art that the electronic device is not limited to the aforementioned devices. The control unit 110 controls general operations and signal flows between internal components of the electronic device 100, and performs data processing. For example, the control unit 110 may be formed with a central processing unit (CPU) and application processor (AP). Further, the control unit 110 may be formed with a single-core processor or multi-core processor.

The control unit 110 according to various embodiments of the present disclosure can control to activate reception lines and transmission lines of a first sensor area and second sensor area. The control unit 110 can identify a fingerprint by detecting a swipe operation in the first sensor area. The swipe operation means a movement of finger (or other part of the body) while contacting with a fingerprint sensor. The control unit 110 can identify a fingerprint by detecting a touch operation in the second sensor area. The touch operation means contacting a finger (or other part of the body) to a fingerprint sensor without any lateral movement.

The control unit 110 can detect a swipe operation in the first sensor area and store identified fingerprint in the storage unit 150. The control unit 110 may release a lock mode or perform a fingerprint authentication by comparing a fingerprint identified through a touch operation in the second sensor area and store the fingerprint in the storage unit 150. In this case, the fingerprint stored by identifying a swipe operation has a wider area of user's fingerprint than the fingerprint stored by identifying a touch operation, and thereby the control unit 110 can decide that both fingerprints are identical, if the fingerprint identified by the touch operation corresponds to a part of the fingerprint identified by the swipe operation.

Further, the control unit 110 can release a lock mode or perform a fingerprint authentication, if the fingerprint identified by the swipe operation in the first sensor area is identical to a fingerprint stored in the storage unit 150. The input unit 120 can transmit a user input command or data to the control unit 110, display unit 130, communication unit 160, and storage unit 150. Further, the input unit 120 may include a touch panel included in a touch screen of the display unit 130. For example, the control unit 110 can detect a signal input through the touch screen.

The display unit 130 may include a display panel and a touch panel integrated in a layer structure. The display panel may be configured in various forms such as an LCD (Liquid Crystal Display), OLED (Organic Light Emitting Diode), AM-OLED (Active-matrix Organic Light-Emitting Diode), or PDP (Plasma Display Panel).

The display panel may be configured in a flexible, transparent, or wearable form. For example, the touch can identify a touch input generated by at least one of capacitive, pressure-sensitive, infrared, or ultrasonic types.

The sensor unit 140 can measure a physical quantity or detect an operation state of the electronic device 100, and convert the measured or detected information to an electric signal. The sensor unit 140 may include a fingerprint sensor 141. According to an embodiment of the present disclosure, the fingerprint sensor 141 may be disposed in a home button of the electronic device 100. In the present disclosure, it is assumed that the fingerprint sensor 141 is installed in the home button. However, the present disclosure is not limited to this example.

The fingerprint sensor 141 may be divided into a first sensor area and a second sensor area. The first sensor area identifies a user's fingerprint by detecting a swipe operation and the second sensor area identifies a user's fingerprint by detecting a touch operation. Each sensor area is formed with a reception line Rx and a transmission line Tx, and the transmission line can be shared by the first sensor area and second sensor area.

The principle of fingerprint recognition is based on a principle that ridges of fingerprint contact the fingerprint sensor and valleys of fingerprint are displaced from the fingerprint when a finger touches a home button installed with the fingerprint sensor. Namely, there is a difference between a distance of the fingerprint ridge from the fingerprint sensor and a distance of the fingerprint valley from the fingerprint sensor. The difference is detected between a transmission line and a reception line intersecting each other, and may be indicated as a difference of capacitance. The capacitance may be indicated in an 8 bit form.

The reception line of first sensor area (i.e., first reception line) may be configured with at least two lines, and when a user performs a swipe operation, a fingerprint image can be generated by recognizing a fingerprint shape and accumulating the lines of fingerprint one by one. Other lines may be regarded as noises. When noises are generated, a fingerprint having a correct form can be identified by eliminating the noises from data for generating the fingerprint image.

The reception line of second sensor area (i.e., second reception line) may be configured with a plurality of reception lines (for example, 56 lines). The second reception line can identify a user's fingerprint by sequentially activating while a user touches the fingerprint sensor 141.

A plurality of transmission lines may be formed (for example, 144 lines). The second reception lines may be configured by intersecting the transmission lines, and the first reception lines may be configured by displacing from the transmission lines in a predetermined distance.

According to another embodiment of the present disclosure, a fingerprint recognized by a swipe operation in the first sensor area may be also identified in the second sensor area. At least two line of the plurality of second reception lines may be activated, and one may be used as a reception line for recognizing a fingerprint and the other one may be used as a reception line for detecting a noise.

The sensor unit 140 may further include a control circuit for controlling at least one sensor included therein.

The storage unit 150 may include at least one of an internal memory or an external memory.

The internal memory may include at least one of a volatile memory such as a DRAM (Dynamic Random Access Memory), SRAM (Static Random Access Memory), and SDRAM (Synchronous Dynamic Random Access Memory); non-volatile memory such as an OTPROM (One Time Programmable Read Only Memory), PROM (Programmable Read Only Memory), EPROM (Erasable and Programmable Read Only Memory), EEPROM (Electrically Erasable and Programmable Read Only Memory), mask read only memory, and flash read only memory; hard disk drive (HDD); or solid state drive (SSD).

The external memory may include at least one of a CF (Compact Flash), SD (Secure Digital), Micro-SD (Micro Secure Digital), Mini-SD (Mini Secure Digital), xD (extreme Digital), or memory stick.

In a registration mode, the storage unit 150 can store a fingerprint recognized by a swipe operation or touch operation. The fingerprint stored in the storage unit 150 may be used by the control unit 110 for comparing with a finger print recognized later.

According to various embodiments of the present disclosure, the electronic device may include a sensor unit 140 having a fingerprint sensor 141 which recognizes a swipe operation in a first sensor area and a touch operation in a second sensor area, control unit 110 configured to identify the swipe operation or touch operation according to movement of finger contacting with the fingerprint sensor 141 and to selectively activate the first sensor area or second sensor area, and storage unit 150 configured to store fingerprint information obtained through an active area of the first sensor area or second sensor area.

According to various embodiments of the present disclosure, the control unit 110 of electronic device controls to activate the second sensor area by identifying a movement of finger contacting with the fingerprint sensor 141, recognizing a swipe operation if the movement of finger is detected on the fingerprint sensor 141, activating the first sensor area, and recognizing a touch operation if the movement of finger is not detected on the fingerprint sensor 141.

According to various embodiments of the present disclosure, the control unit 110 of electronic device executes a registration mode which fingerprint information according to the swipe operation is obtained as registration fingerprint information if the first sensor area is activated, and stores the registration fingerprint information in the storage unit 150.

According to various embodiments of the present disclosure, an authentication mode is performed to obtain the fingerprint information according to the touch operation as an authentication fingerprint information if the second sensor area of electronic device is activated, and an identity is decided by comparing the authentication fingerprint information with the registration fingerprint information.

According to various embodiments of the present disclosure, the second sensor area of electronic device may include at least one transmission line for transmitting a sensing voltage, at least one second reception line disposed by intersecting the transmission line for receiving the sensing voltage, at least one transmission line switch which selectively activates the transmission of sensing voltage through the transmission line, and at least one second reception line switch which selectively activates the sensing voltage of each reception line.

According to various embodiments of the present disclosure, if the second sensor area is activated, the control unit 110 of electronic device controls to sequentially activate at least one second reception line switch and at least one transmission line switch, so that at least one intersecting point between at least one transmission line corresponding to the transmission line switch and at least one reception line corresponding to the second reception line switch can be sequentially activated.

According to various embodiments of the present disclosure, if one of the transmission line switches and one of the second reception line switches are activated at the same time, the control unit 110 of electronic device obtains fingerprint information at the intersecting point between the corresponding transmission line and reception line.

According to various embodiments of the present disclosure, the first sensor area of electronic device may include at least one transmission line for transmitting a sensing voltage, at least one first reception line disposed to displace from the transmission line in a predetermined distance for receiving the sensing voltage from the transmission line, and at least one first reception line switch for selectively opening or closing the reception of sensing voltage for each reception line.

According to various embodiments of the present disclosure, if the second sensor area of electronic device is activated, at least one second reception line switch is sequentially activated and at least one transmission line switch is sequentially activated in a state that one of the second reception lines is activated, so that at least one intersecting point between at least one transmission line corresponding to the transmission line switch and at reception line corresponding to the second reception line switch can be sequentially activated.

According to various embodiments of the present disclosure, if one of the transmission line switches and one of the second reception line switches are activated at the same time, the control unit 110 of electronic device obtains fingerprint information at the intersecting point between the corresponding transmission line and reception line.

According to various embodiments of the present disclosure, the first sensor area of electronic device may include at least one transmission line for transmitting a sensing voltage, at least one first reception line disposed to displace from the transmission line in a predetermined distance for receiving the sensing voltage from the transmission line, and at least one first reception line switch for selectively opening or closing the reception of sensing voltage for each reception line.

According to various embodiments of the present disclosure, if the first sensor area is activated, the control unit 110 of electronic device deactivates all the at least one second reception line switch and sequentially activates the at least one transmission switch in a state that one of the first reception line switches is activated, so that at least one intersecting point between at least one transmission line corresponding to the transmission line switch and at least one reception line corresponding to the second reception line switch can be sequentially activated.

According to various embodiments of the present disclosure, if the second sensor area is activated, the control unit 110 of electronic device sequentially activates the at least one second reception line switch and sequentially activates the at least one transmission switch in a state that one of the second reception line switches is activated, so that at least one intersecting point between at least one transmission line corresponding to the transmission line switch and at least one reception line corresponding to the second reception line switch can be sequentially activated.

According to various embodiments of the present disclosure, if one of the transmission line switches and one of the second reception line switches are activated at the same time, the control unit 110 of electronic device obtains fingerprint information at the intersecting point between the corresponding transmission line and reception line.

According to various embodiments of the present disclosure, the first sensor area of electronic device may include at least one transmission line for transmitting a sensing voltage, at least one first reception line disposed by displacing from the transmission line in a predetermined distance for receiving the sensing voltage from the transmission line, and at least one first reception line switch for selectively opening or closing the reception of sensing voltage for each reception line.

According to various embodiments of the present disclosure, if the first sensor area is activated, the control unit 110 of electronic device deactivates all the at least one second reception line switch and sequentially activates the at least one transmission switch in a state that one of the first reception line switches is activated, so that at least one intersecting point between at least one transmission line corresponding to the transmission line switch and at least one reception line corresponding to the second reception line switch can be sequentially activated.

According to various embodiments of the present disclosure, if one of the transmission line switches and one of the second reception line switches are activated at the same time, the control unit 110 of electronic device obtains fingerprint information at a distance between the corresponding transmission line and reception line.

According to various embodiments of the present disclosure, if the second sensor area is activated, the control unit 110 of electronic device deactivates all the at least one first reception line switch.

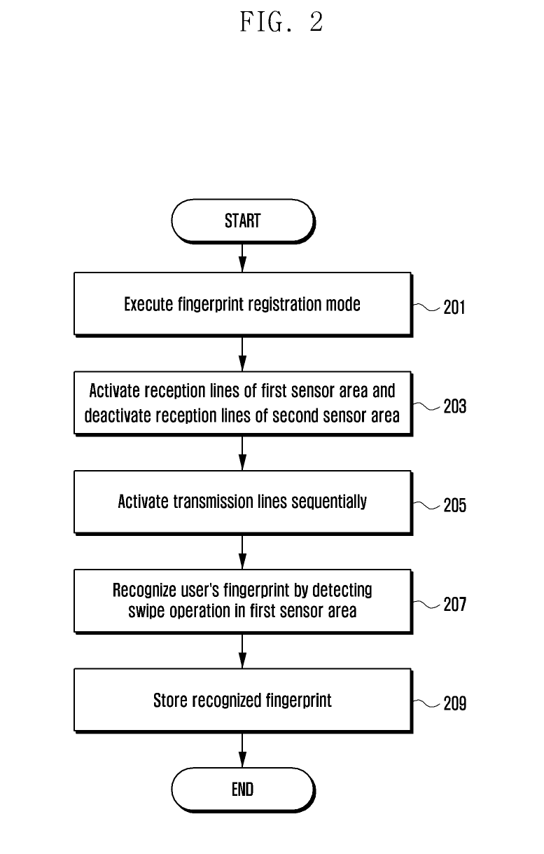

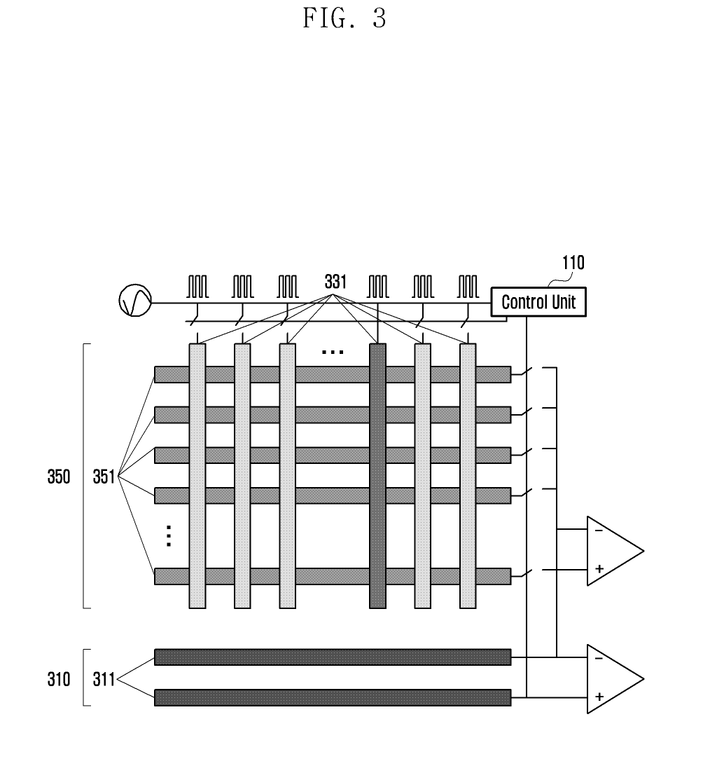

FIG. 2 is a flowchart illustrating a method for registering and authenticating a fingerprint according to various embodiments of the present disclosure. FIG. 3 is a drawing illustrating a fingerprint sensor 141 for registering and authenticating a fingerprint according to various embodiments of the present disclosure.

Referring to FIG. 2, the control unit 110 executes a fingerprint registration mode which obtains fingerprint information as registration fingerprint information at operation 201. The control unit 110 can execute or switch to the fingerprint registration mode by identifying a user's selection (e.g., of a designated button, input, icon, etc.). Further, when executing an application using a finger print, the control unit 110 can execute or switch to the fingerprint registration mode by identifying a fingerprint registration request.

The control unit 110 activates first reception lines 311 and deactivates second reception lines 351 to register a fingerprint according to a swipe operation at operation 203. The control unit 110 sequentially activates transmission lines 331 at operation 205.

The control unit 110 obtains fingerprint information as registration fingerprint information by detecting a user's swipe operation on a first sensor area 310 at operation 207. In order to enhance recognition, the control unit 110 may display a notice requesting the user to perform fingerprint operations repeatedly. The number of requests may be set by the user.

The control unit 110 stores the obtained registration fingerprint information at operation 209. If a plurality of fingerprints is obtained according to the repeated operations, the control unit 110 may accumulate the plurality of fingerprints and store a fingerprint to be used for comparing with authentication fingerprint information.

Referring to FIG. 3, the fingerprint sensor 141 is configured with a first sensor area 310 and a second sensor area 350, and each sensor area may be configured with first reception lines 311, second reception lines 351, and transmission lines 331. Each line can be activated or deactivated by the control unit 110 through at least one switch connected to each line. Referring to FIG. 3, the first reception line 311, second reception line 351, and transmission line 331 can be activated respectively by a first reception line switch, second reception line switch, and transmission line switch.

When registering a fingerprint with a swipe operation, the control unit 110 can activate all the first reception lines 311 by controlling opening and closing of the first reception line switch. The control unit 110 can sequentially activate the first to N-th line (for example, 1st—144th transmission line) of the first reception lines 311 by controlling opening and closing of the transmission line switch. At least one intersecting point between at least one transmission line corresponding to the transmission line switch and at least one first reception line corresponding to the first reception line switch can be sequentially activated.

The control unit 110 supplies a voltage through the activated transmission lines 331, and the first reception line can receive the voltage from the activated transmission line. The control unit 110 can obtain noiseless fingerprint information from a voltage change received from the first reception line by passing through an operational amplifier (OP-Amp).

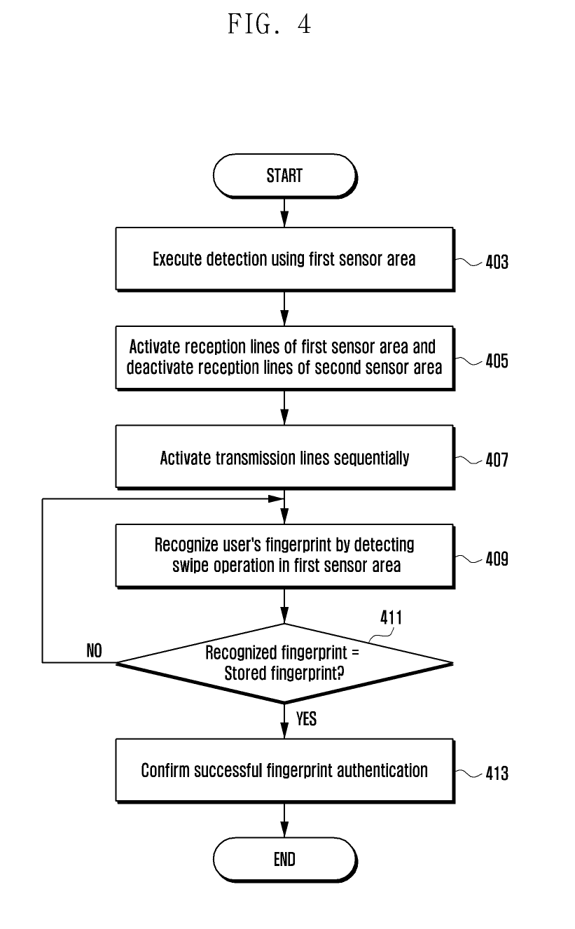

FIG. 4 is a flowchart illustrating a method for registering and authenticating a fingerprint according to various embodiments of the present disclosure, which executes a fingerprint authentication mode according to a swipe operation.

Referring to FIG. 4, the control unit 110 executes fingerprint detection by using the first sensor area 310 at operation 403.

The control unit 110 can activate the first reception lines 311. Further, the control unit 110 can deactivate the second reception lines 351 at operation 405. This is to perform a fingerprint authentication mode in which the control unit 110 performs a user authentication by recognizing a fingerprint with a swipe operation.

The control unit 110 sequentially activates the transmission lines 331 at operation 407. The control unit 110 obtains fingerprint information as authentication fingerprint information by detecting a swipe operation in the first sensor area 310 at operation 409. The control unit 110 identifies whether the obtained authentication fingerprint information is identical to registration fingerprint information stored in the storage unit 150 at operation 411.

If the authentication fingerprint information is identical to the registration fingerprint information, the control unit 110 confirms successful fingerprint authentication at operation 413. If the authentication fingerprint information is not identical to the registration fingerprint information, the control unit 110 can re-perform the user's fingerprint recognition by returning to operation 409.

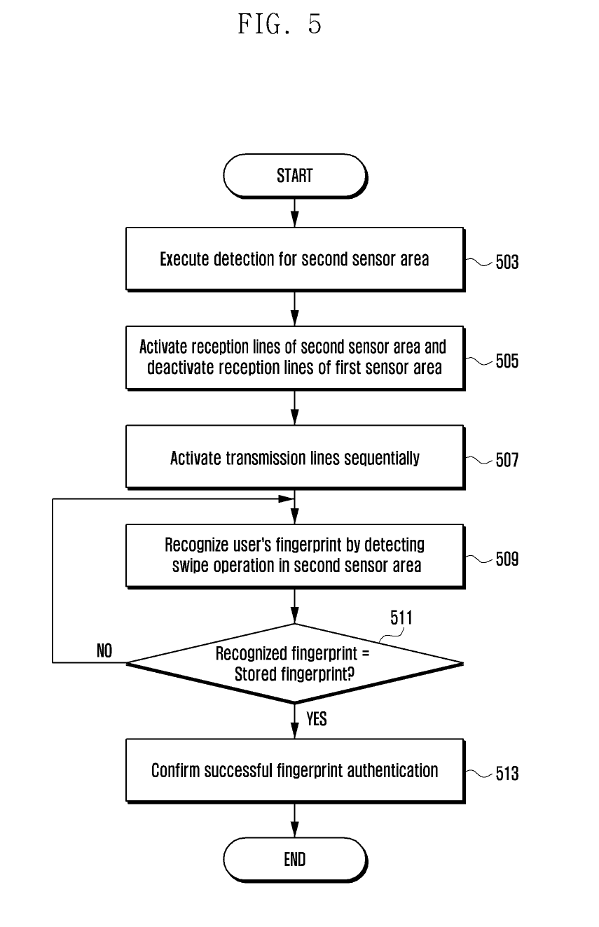

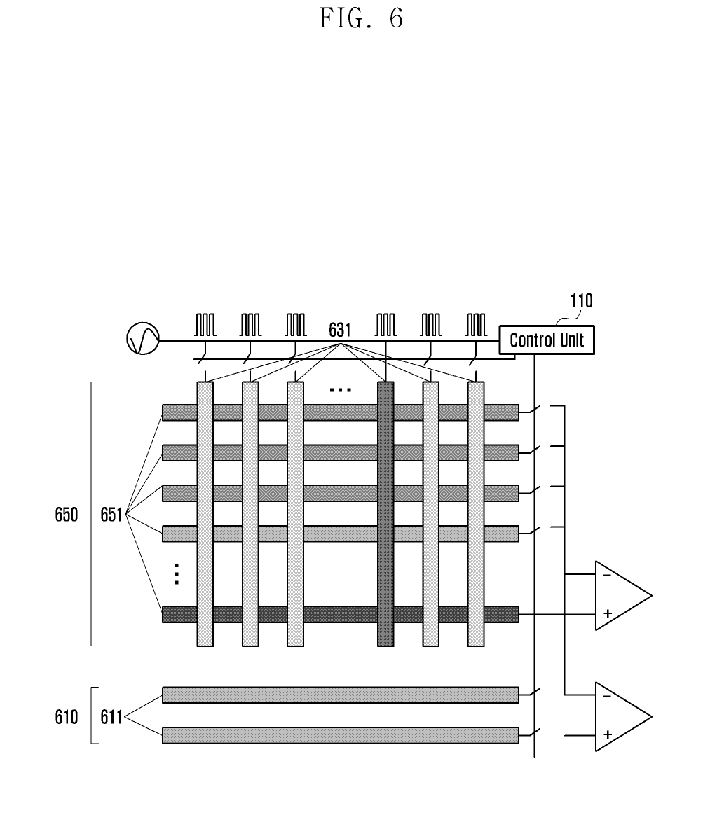

FIG. 5 is a flowchart illustrating a method for registering and authenticating a fingerprint according to various embodiments of the present disclosure, which executes a fingerprint recognition mode according to a touch operation. FIG. 6 is a drawing illustrating a fingerprint sensor 141 executing operations of FIG. 5.

Referring to FIG. 5, the control unit 110 detects for a second sensor area 650 at operation 503. Further, the control unit 110 can identify a command for detecting a fingerprint using the second sensor area 650.

The control unit 110 sequentially activates the second reception lines 651 at operation 505. Further, the control unit 110 can deactivate the first reception lines 611. The control unit 110 sequentially activates the transmission lines 631 at operation 507.

The control unit 110 obtains fingerprint information as authentication fingerprint information by detecting a touch operation in the second sensor area 650 at operation 509. The control unit 110 identifies whether the obtained authentication fingerprint information is identical to registration fingerprint information stored in the storage unit 150 at operation 511.

If the authentication fingerprint information is identical to the registration fingerprint information, the control unit 110 confirms successful fingerprint authentication at operation 513. If the authentication fingerprint information is not identical to the registration fingerprint information at operation 511, the control unit 110 returns to operation 509 and reattempts authentication of a user's fingerprint again by detecting another touch operation in the second sensor area 650.

Referring to FIG. 6, the fingerprint sensor 141 may be configured with a first sensor area 610 and a second sensor area 650, and may be configured respectively with first reception lines 611 for the first sensor area 610, second reception lines 651, and transmission lines 631 for the second sensor area 650. Each line can be activated or deactivated by the control unit 110 through a switch.

When recognizing a fingerprint with a touch operation, the control unit 110 can sequentially activate the first to M-th line (for example, 1st—56th reception line) of the second reception lines 651 by controlling opening and closing of the second reception line switch.

Further, the control unit 110 can sequentially activate the first to N-th line (for example, 1st—144th transmission line) of the transmission lines 631 by controlling opening and closing of the transmission line switch. Accordingly at least one intersecting point between at least one transmission line corresponding to the transmission line switch and at least one second reception line corresponding to the second reception line switch can be sequentially activated.

The control unit 110 can supply a voltage to the activated transmission lines 631, and receive a voltage from the second reception line 651 which received the voltage at an interesting point with the activated transmission line 631. The control unit 110 can obtain noiseless fingerprint information by passing the voltage received from the second reception line 651 through an OP-Amp.

For example, the control unit 110 can sequentially activate the first to N-th line of the second reception lines 651 in a state that the line is activated. Subsequently, the control unit 110 can sequentially activate the first to N-th line of the transmission line 631 at a state that the second line of the second reception lines 651 is activated.

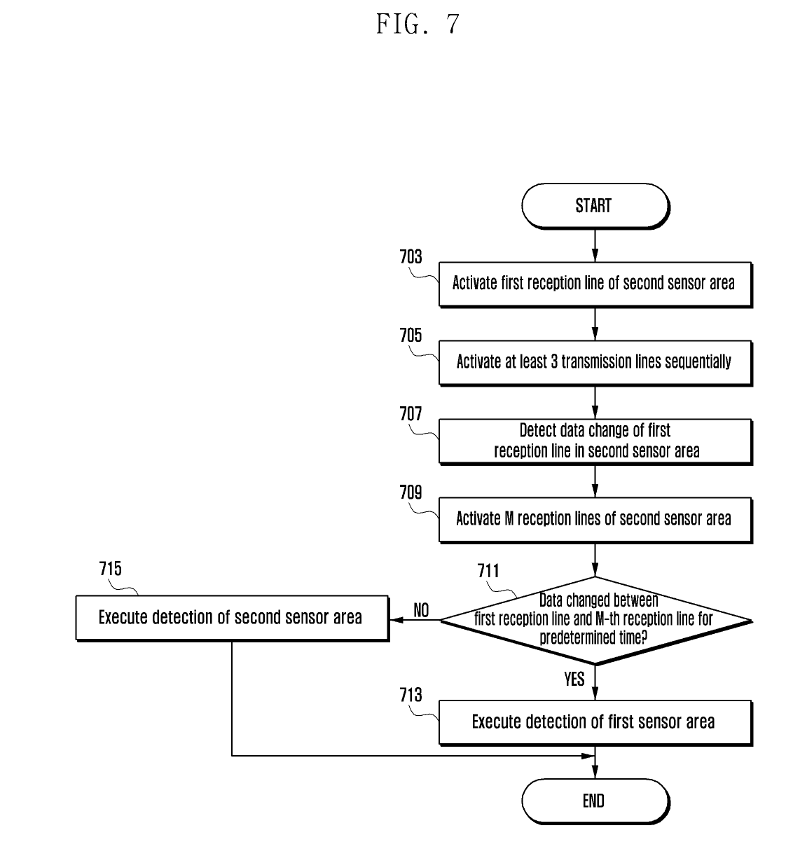

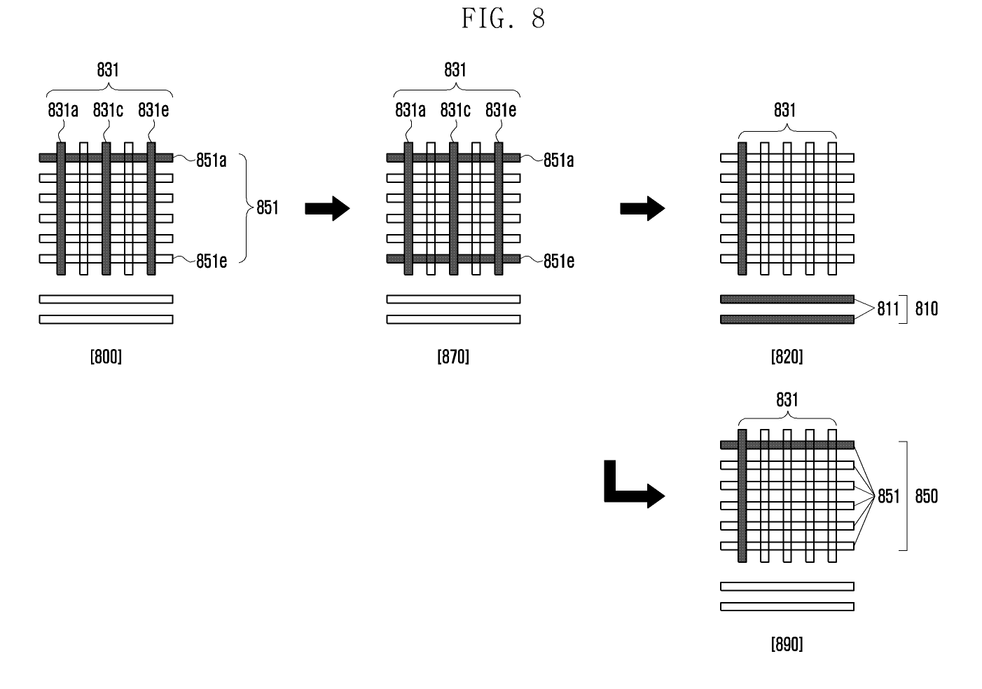

FIG. 7 is a flowchart illustrating a method for registering and authenticating a fingerprint according to various embodiments of the present disclosure. FIG. 8 is a drawing illustrating a fingerprint sensor 141 executing operations of FIG. 7.

Referring to FIG. 7, the above operations can be performed to authenticate a user in a lock mode before entering a home screen, and can be performed to obtain specific information in an application utilizing user authentication as another embodiment. Referring to FIG. 8, the control unit 110 activates the reception line 851a at operation 703 as shown by reference number 800.

The control unit 110 sequentially activates at least 3 lines from the transmission lines 831 at operation 705. For example, the control unit 110 can sequentially activate the first transmission line 831a, N/2-th transmission line 831c, and N-th transmission line 831e.

The control unit 110 detects a data change of at least one intersecting point between the first line 851a of the second reception lines 851 and the transmission lines 831 at operation 707. The data change of intersecting point can be used to identify whether a user's finger is located on a sensor. If the data change of intersecting point is detected at operation 707, the control unit 110 activates M-th line 851e of the second reception lines 851 at operation 709 as shown by reference number 870. The control unit 110 can detect a data change of interesting point between M-th line 851e of the second reception lines 851 and at least one of the transmission lines 831.

The control unit 110 identifies whether a data change is generated at an intersecting point of the first line 851a of the second reception line 851 and the transmission lines 831, and at an intersecting point of M-th line 851e of the second reception line 851 and the transmission lines 831 at operation 711. If a data change is detected at operation 711, the control unit 110 detects a fingerprint through the first sensor area 810 at operation 713.

The detection of data change between the intersecting points at operation 711 indicates that a user has performed a swipe operation with a finger, and thereby the control unit 110 can detect a fingerprint from the swipe operation through the first sensor area 810. As shown by reference number 820, the first sensor area 810 can perform a detection of fingerprint. Further, the control unit 110 can activate the first reception lines 811 in the first sensor area 810 and sequentially activate the transmission lines 831.

If a data change between intersecting points is not detected at operation 711, the control unit 110 detects a fingerprint through the second sensor area 850 at operation 715. No detection of intersecting points at operation 711 indicates that a user's finger did not move while in a state of contact (e.g., touching), and thereby the control unit 110 can detect a fingerprint through the second sensor area 850.

As shown by reference number 890 of FIG. 8, the second sensor area 850 can detect a fingerprint. Further, the control unit 110 can sequentially activate the second reception lines 851 and the transmission lines 831.

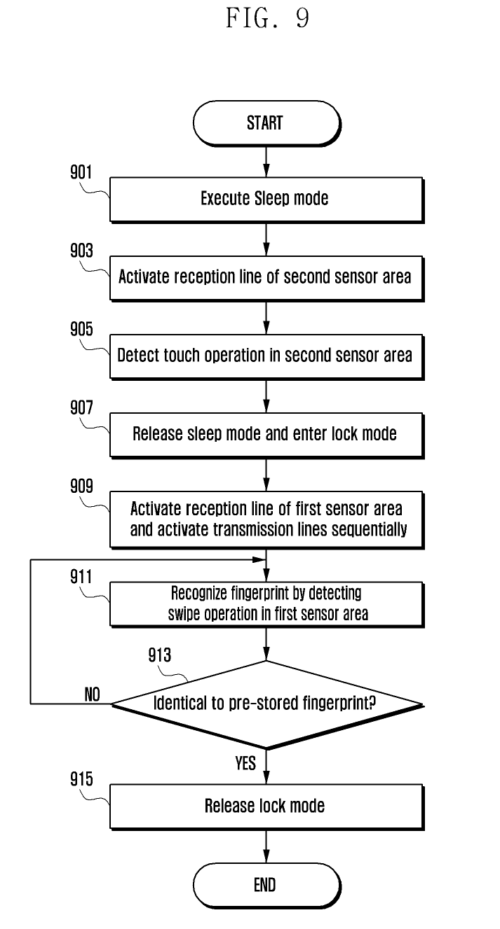

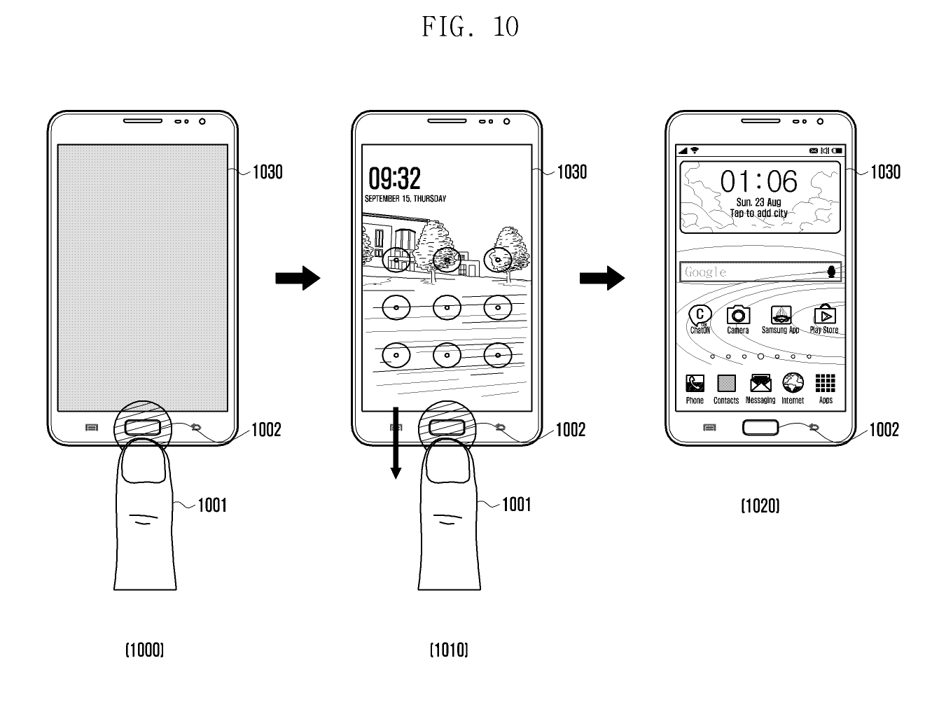

FIG. 9 is a flowchart illustrating a method for registering and authenticating a fingerprint according to various embodiments of the present disclosure. FIG. 10 illustrates screen examples of registering and authenticating a fingerprint according to various embodiments of the present disclosure.

Referring to FIG. 9, the electronic device 100 is in a sleep mode at operation 901. Namely, as shown by reference number 1000 of FIG. 10, the electronic device 100 may be in a sleep mode. The sleep mode may be a state that a display unit 1030 of electronic device 100 is switched off. Further the sleep mode may be a state that the control unit 110 is in a sleeping state, but the fingerprint sensor is in an active state by control by and/or connection to an auxiliary control unit.

In the sleep mode of the display unit 1030 of electronic device 100, a user may touch a finger 1001 on a home button 1002 installed with a fingerprint sensor 141. The auxiliary control unit activates the second reception lines at operation 903. The auxiliary control unit may detect the existence of a finger in the second sensor area at operation 905.

As shown by reference number 1010, if the finger 1001 is identified, then in operation 907, the auxiliary control unit may release the sleep mode and enter a lock mode. Here, the control unit may “wake up” by releasing the sleep mode.

The control unit 110 “wake up” at operation 909 can include activation of the first reception line. Further, the control unit 110 may sequentially activate transmission lines. As shown by reference number 1010, in the lock state, a user can perform a swipe operation being executed by the finger on the home button 1002 installed with the fingerprint sensor 141.

The control unit 110 recognizes a fingerprint by detecting a swipe operation in the first sensor area at operation 911. The control unit 110 identifies whether the recognized fingerprint is identical to a finger print stored in the storage unit 150 at operation 913. If the recognized fingerprint is identical to the fingerprint stored in the storage unit 150, the control unit 110 releases the lock mode at operation 915, as shown in reference number 1020.

If the recognized fingerprint is not identical to the fingerprint stored in the storage unit 150, the control unit 110 returns to operation 911 and requests a new swipe operation in the first sensor area, and re-executes recognition of a fingerprint by detecting a swipe operation. The number of requests or reattempts can be limited and/or set by a user.

According to various embodiments of the present disclosure, a method of sequentially activating transmission lines at a state of activating one of reception lines in a fingerprint registration mode or fingerprint authentication mode has been described above, however the method can be implemented in the opposite way. Namely, the reception lines can be sequentially activated at a state of activating one of the transmission lines.

According to various embodiments of the present disclosure, a method for registering and authenticating a fingerprint may include operations of identifying a swipe operation or touch operation according to a movement of finger contacting with a fingerprint sensor 141, activating a first sensor area or second sensor area of the fingerprint sensor selectively according to the result of identification, and storing fingerprint information obtained through an activated area of the first sensor area or second sensor area.

According to various embodiments of the present disclosure, a method for registering and authenticating a fingerprint may include an operation of activating the second sensor area by identifying the movement of finger contacting the fingerprint sensor 141, recognizing a swipe operation if the movement of finger on the fingerprint sensor 141 generates, and activating the first sensor area, and recognizing a touch operation if the movement of finger on the fingerprint sensor 141 doesn't generate.

According to various embodiments of the present disclosure, a method for registering and authenticating a fingerprint may include operations of executing a registration mode which obtains fingerprint information according to the swipe operation as registration fingerprint information if the first sensor area is activated and storing the obtained registration fingerprint information in the storage unit 150.

According to various embodiments of the present disclosure, a method for registering and authenticating a fingerprint may include operations of executing an authentication mode which obtains fingerprint information according to the touch operation as authentication fingerprint information if the second sensor area is activated and identifying a coincidence by comparing the authentication fingerprint information with the registration fingerprint information.

According to various embodiments of the present disclosure, in the method for registering and authenticating a fingerprint, the second sensor area may include at least one transmission line configured to transmit a sensing voltage, at least one second reception line configured to intersect the transmission line and to receive the sensing voltage from the transmission line, at least one transmission line switch configured to selectively activate transmission of sensing voltage for each transmission line, and at least one second reception line switch configured to selectively activate reception of sensing voltage for each reception line.

According to various embodiments of the present disclosure, the method for registering and authenticating a fingerprint may include an operation of sequentially activating at least one intersecting point between a transmission line corresponding to the at least one transmission line switch and a reception line corresponding to the at least one second reception line switch by sequentially activating the at least one second reception line switch if the second sensor area is activated and by sequentially activating the at least one transmission line switch in a state that one of the second reception line switches is activated.

According to various embodiments of the present disclosure, the method for registering and authenticating a fingerprint may include an operation of obtaining the fingerprint information from the intersecting point between the corresponding transmission line and reception line if one of the transmission line switches and one of the second reception line switches becomes an active state at the same time.

According to various embodiments of the present disclosure, in the method for registering and authenticating a fingerprint, the first sensor area may include at least one transmission line configured to transmit a sensing voltage, at least one first reception line disposed by displacing a predetermined distance from the transmission line and configured to receive the sensing voltage from the transmission line, and at least one first reception line switch configured to selectively open or close the reception of sensing voltage for each reception line.

According to various embodiments of the present disclosure, the method for registering and authenticating a fingerprint may include an operation of sequentially activating at least one intersecting point between a transmission line corresponding to the at least one transmission line switch and a reception line corresponding to the at least one second reception line switch by deactivating all the at least one second reception line switch if the first sensor area is activated and by sequentially activating the at least one transmission line switch in a state that one of the first reception line switches is activated.

According to various embodiments of the present disclosure, the method for registering and authenticating a fingerprint may include an operation of obtaining the fingerprint information from a distance between the corresponding transmission line and reception line if one of the transmission line switches and one of the second reception line switches becomes an active state at the same time.

According to various embodiments of the present disclosure, the method for registering and authenticating a fingerprint may include an operation of deactivating all the at least one first reception line switch if the second sensor area is activated.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include language code executable by computers using an interpreter as well as machine language codes created by a compiler. The aforementioned hardware device can be implemented with one or more software modules for executing the operations of embodiments of the present disclosure.

A module or programming module of the present disclosure may include at least one of the aforementioned components while omitting some components and/or adding other components. Operations of the modules, programming modules, or other components may be executed in series, in parallel, recursively, or heuristically in accordance with embodiments of the present disclosure. Some operations may be executed in a different order, omitted, or extended. According to various embodiments of the present disclosure, a method for registering and authenticating a fingerprint and an electronic device implementing the same can utilize a swipe operation when registering a large number of detailed images, and can utilize a touch operation for quickly and precisely authenticating a brief image for user conveniences.

Further, a proper method can be easily adopted according to a user's finger movement on a fingerprint recognition sensor.

Further, a sleep mode can be released by detecting the user's finger movement on the fingerprint recognition sensor.

While the present disclosure has been shown and described with reference to certain embodiment thereof, it will be understood by those skilled in the art that various changes in form and details may be made therein without departing from the present disclosure as defined by the appended claims and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. An electronic device comprising:
a sensor unit including a first sensor area for detecting a fingerprint via a swipe operation and a second sensor area for detecting the fingerprint via a touch operation; and
at least one processor configured to:
detect a touch input to the sensor unit and activating one of the first sensor area and the second sensor area according to whether the touch input is the swipe operation or the touch operation; and
store fingerprint information obtained through the activated first sensor area or second sensor area.

2. The electronic device of claim 1, wherein the at least one processor is further configured to:
activate the first sensor area when the touch input is the swipe operation as indicated by movement of the touch input; and
activate the second sensor area when the touch input is the touch operation as indicated by no movement of the touch input.

3. The electronic device of claim 1, further comprising a storage unit, wherein the at least one processor is further configured to execute a registration mode where fingerprint information received from the swipe operation to the activated first sensor area is stored as registration fingerprint information in the storage unit.

4. The electronic device of claim 3, wherein the at least one processor is further configured to execute an authentication mode in which a fingerprint is detected from the sensor unit according to the activated second sensor area, and the detected fingerprint is compared against the registration fingerprint information.

5. The electronic device of claim 1, wherein the second sensor area comprises:
one or more transmission lines configured to transmit a sensing voltage;
one or more second reception lines configured to intersect with the one or more transmission lines and to receive the sensing voltage from the one or more transmission lines;
one or more transmission line switches configured to selectively activate transmission of sensing voltage for the one or more transmission lines; and
one or more second reception line switches configured to selectively activate reception of sensing voltage for each of the one or more reception lines.

6. The electronic device of claim 5, wherein the at least one processor is further configured to:
sequentially activate at least one intersecting point between a transmission line corresponding to the one or more transmission line switches and a reception line corresponding to the one or more second reception line switches by:
sequentially activating the one or more second reception line switches when the second sensor area is activated, and
sequentially activating the one or more transmission line switches in a state that one of the one or more second reception line switches is activated.

7. The electronic device of claim 6, wherein the at least one processor is further configured to obtains the fingerprint information from the at least one intersecting point when one of the one or more transmission line switches and the one or more second reception line switches becomes active concurrently.

8. The electronic device of claim 6, wherein the first sensor area further comprises:
one or more transmission lines configured to transmit a sensing voltage;
one or more first reception lines displaced a predetermined distance from each of the one or more transmission lines, respectively, and configured to receive the sensing voltage from each of the one or more transmission line; and
one or more first reception line switches configured to selectively open or close the reception of sensing voltage for each of the one or more first reception lines.

9. The electronic device of claim 8, wherein the at least one processor is further configured to:
sequentially activate at least one intersecting point between a transmission line corresponding to the one or more transmission line switches and a reception line corresponding to the one or more second reception line switches by:
deactivating all of the one or more second reception line switches when the first sensor area is activated, and
sequentially activating the one or more transmission line switches when one of the one or more first reception line switches is activated.

10. The electronic device of claim 9, wherein the at least one processor is further configured to detect the fingerprint information according to a distance between a corresponding transmission line and reception line if one of the one or more transmission line switches and one of the one or more second reception line switches becomes active concurrently.

11. The electronic device of claim 8, wherein the at least one processor deactivates all of the one or more first reception line switches if the second sensor area is activated.

12. A fingerprint authentication method, comprising:
detecting by at least one processor a touch input to a fingerprint sensor and determining whether the touch input is a swipe operation or a touch operation according to whether the touch input includes movement;
activating one of a first sensor area and a second sensor area of the fingerprint sensor according to the determination; and
storing fingerprint information received through the activated first sensor area or second sensor area.

13. The method of claim 12, further comprising activating the first sensor area when the touch input is the swipe operation as indicated by movement of the touch input; and
activate the second sensor area when the touch input is the touch operation as indicated by no movement of the touch input.

14. The method of claim 12, further comprising executing a registration mode where fingerprint information received from the swipe operation to the activated first sensor area is stored as registration fingerprint information in a storage unit.

15. The method of claim 14, further comprising executing an authentication mode in which a fingerprint is detected from the fingerprint sensor according to the activated second sensor area, and comparing the detected fingerprint against the registration fingerprint information.

16. The method of claim 12, wherein the second sensor area comprises:
one or more transmission lines configured to transmit a sensing voltage;
one or more second reception lines configured to intersect with the one or more transmission lines and to receive the sensing voltage from the one or more transmission lines;
one or more transmission line switches configured to selectively activate transmission of sensing voltage for each of the one or more transmission lines; and
one or more second reception line switches configured to selectively activate reception of sensing voltage for each of the one or more reception lines.

17. The method of claim 16, further comprising:
sequentially activating at least one intersecting point between a transmission line corresponding to the one or more transmission line switches, and a reception line corresponding to the one or more second reception line switches by:
sequentially activating the one or more second reception line switches when the second sensor area is activated, and
sequentially activating the one or more transmission line switches in a state that one of the one or more second reception line switches is activated.

18. The method of claim 17, wherein the fingerprint information is obtained from the at least one intersecting point when one of the one or more transmission line switches and one of the one or more second reception line switches becomes active concurrently.

19. The method of claim 16, wherein the first sensor area comprises:
one or more transmission lines configured to transmit a sensing voltage;
one or more first reception lines displaced a predetermined distance from each of the one or more transmission lines, respectively, and configured to receive the sensing voltage from each of the one or more transmission lines; and
one or more first reception line switches configured to selectively open or close the reception of sensing voltage for each of the one or more first reception lines.

20. The method of claim 19, further comprising:
sequentially activating at least one intersecting point between a transmission line corresponding to the one or more transmission line switches and a reception line corresponding to the one or more second reception line switches by:
deactivating all of the one or more second reception line switches when the first sensor area is activated, and
sequentially activating the one or more transmission line switches when one of the one or more first reception line switches is activated.

21. The method of claim 20, wherein the fingerprint information is detected according to a distance between a corresponding transmission line and reception line if one of the one or more transmission line switches and one of the one or more second reception line switches becomes active concurrently.

22. The method of claim 19, wherein all of the one or more first reception line switches are deactivated if the second sensor area is activated.
